(19) United States
(12) Patent Application Publication
(10) Pub. No.: US 2017/0061501 A1
(43) Pub. Date: Mar. 2, 2017

(54) METHOD AND SYSTEM FOR PREDICTING DATA WAREHOUSE CAPACITY USING SAMPLE DATA

(71) Applicant: KING.COM LIMITED, St. Julians (MT)

(72) Inventor: Adam HORWICH, London (GB)

(21) Appl. No.: 14/842,098

(22) Filed: Sep. 1, 2015

(51) Int. Cl. G06Q 30/02; G06F 17/30

(52) U.S. Cl. CPC G06Q 30/0275; G06F 17/30592

(57) ABSTRACT

A method for predicting a storage capacity requirement for storing auction event data, the method comprising: recording electronic auction activities communicated between a server and one or more ad exchanges, wherein each activity recorded comprises client data and is stored as a respective auction event; recording metrics data for the auction activities; estimating a size of an auction event; and determining an estimate of a storage capacity requirement for storing said auction events in dependence on said metrics data and said estimated size of an auction event.

### TECHNICAL FIELD OF THE INVENTION

The present disclosure is directed to the storage of data handled by a demand side platform.

### BACKGROUND OF THE INVENTION

A demand side platform (DSP) is a system that allows buyers of digital advertising inventory to manage multiple ad exchange and data exchange accounts through one interface. Real-time bidding (RTB) ad auctions for displaying online advertising takes place within ad exchanges, and by utilizing a DSP, marketers can manage their bids for advertisements placed and the pricing for the data that they display to users who make up their target audiences.

DSPs incorporate many features previously offered by advertising networks, such as wide access to inventory and vertical and lateral targeting, with the ability to serve ads, real-time bid on ads, track the ads, and optimize based on set Key Performance Indicators such as effective Cost per Click, and effective Cost per Acquisition. This is all kept within one interface which allows advertisers to control and maximize the impact of their ads. The sophistication of the level of detail that can be tracked by DSPs is increasing, including frequency information, multiple forms of rich media ads, and some video metrics.

DSPs are commonly used for retargeting, as they able to see a large volume of inventory in order to recognize an ad call (or auction request for bid, RFB) with a user that an advertiser is trying to reach. The percentage of bids that are successfully won over the bids that were submitted is called a win rate.

However, there is a problem with current DSP systems in that as more and more data relating to auction requests, bids and wins are recorded by a DSP, it becomes difficult to properly store, manage and effectively utilise this data again in the future.

### SUMMARY OF THE INVENTION

According to a first aspect of the present disclosure there is provided a method for predicting a storage capacity requirement for storing auction event data, the method comprising: recording electronic auction activities communicated between a server and one or more ad exchanges, wherein each activity recorded comprises client data and is stored as a respective auction event; recording metrics data for the auction activities; estimating a size of an auction event; and determining an estimate of a storage capacity requirement for storing said auction events in dependence on said metrics data and said estimated size of an auction event.

In embodiments the auction activities may comprise: auction requests, bid responses and auction wins.

The method may comprise recording a subset of auction requests.

The method may comprise recording all of the bid responses and auction wins.

The step of recording a subset of auction requests may be based on an adjustable sampling rate; and the adjustable sampling rate may be based on a volume of auction requests.

The method may comprise retrieving the metrics data; and scaling down the number of retrieved metrics that indicate the auction requests in dependence on information on the sampling rate used in recording the subset of auction requests.

The method may comprise providing said auction events in the form of a log file for storing at a data warehouse; and the size of one auction event may be the amount of data needed to represent the auction activity in a line of said log file.

The method may comprise retrieving the metrics data based on a query structure that sets a time interval, so that metrics data from auction activities recorded during the time interval are retrieved.

The method may comprise recording metrics data for auction activities associated with users of a group that access a particular online service; and the step of determining an estimate of a storage capacity requirement for storing said auction events may be for storing auction events associated with the users of the particular online service.

The method may comprise determining, based on the metrics data, a ratio of total number of auction activities recorded to the number of auction requests that originate from said users of the particular online service; and said determining an estimate of a storage capacity requirement for storing auction events associated with the users of the particular online service may comprise performing an operation using information of the result of the ratio and the estimated size of an auction event.

The method may comprise, prior to recording the metrics data, filtering the metrics data such that metrics data according to predefined settings are recorded.

The method may comprise applying an adjustable level of compression to the recorded auction events, the level of compression based on a volume of auction activities.

The method may comprise estimating the level of compression and scaling down the estimate of a storage capacity requirement based on the estimated level of compression.

The method may comprise visually rendering the estimate of a storage capacity requirement for storing said auction events.

According to a second aspect of the present disclosure there is provided a system for predicting a storage capacity requirement for storing auction event data, the system comprising: a server configured to record electronic auction activities communicated between said server and one or more ad exchanges, wherein each activity recorded comprises client data and is stored as a respective auction event; a metrics server configured to record metrics data for the auction activities; a dashboard service configured to estimate a size of an auction event; and wherein the dashboard service is further configured to estimate a storage capacity requirement for storing said auction events in dependence on said metrics data and said estimated size of an auction event.

According to a third aspect of the present disclosure there is provided a method for predicting a storage capacity requirement for storing recorded auction activity data, the method comprising: retrieving recorded metrics data based on electronic auction activities communicated between a server and one or more ad exchanges; estimating a size of an auction activity as recorded by the server; determining an estimate of a storage capacity requirement for storing recorded auction activities in dependence on said metrics data and said estimated size of a recorded auction activity; and providing an indication of said estimated storage capacity requirement.

In embodiments the auction activities may comprise: auction requests, bid responses and auction wins.

The step of retrieving recorded metrics data may comprise retrieving metrics data for auction activities associated with users of a group that access a particular online service; wherein the determining an estimate of a storage capacity requirement for storing said recorded auction activities may be for storing recorded auction activities associated with the users of the particular online service.

The method may comprise determining, based on the metrics data, a ratio of the total number of auction activities recorded to the number of auction requests that originate from said users of the particular online service; and wherein said determining an estimate of a storage capacity requirement for storing recorded auction activities associated with the users of the particular online service may comprise performing an operation using information of the result of the ratio and the estimated size of a recorded auction activity.

The retrieved metrics data may comprise filtered metrics such that metrics data according to predefined settings are retrieved.

According to a fourth aspect of the present disclosure there is provided a computing device adapted to predict a storage capacity requirement for storing recorded auction activity data, the computing device comprising processing means configured to: retrieve recorded metrics data based on electronic auction activities communicated between a server and one or more ad exchanges; estimate a size of an auction activity as recorded by the server; determine an estimate of a storage capacity requirement for storing recorded auction activities in dependence on said metrics data and said estimated size of an auction activity; and provide an indication of said estimated storage capacity requirement.

According to a fifth aspect of the present disclosure there is provided a non-transitory computer readable medium encoded with instructions for controlling a computing device to predict a storage capacity requirement for storing recorded auction activity data, wherein the instructions running on one or more processors result in: retrieving recorded metrics data based on electronic auction activities communicated between a server and one or more ad exchanges; estimating a size of an auction activity as recorded by the server; determining an estimate of a storage capacity requirement for storing recorded auction activities in dependence on said metrics data and said estimated size of an auction activity; and providing an indication of said estimated storage capacity requirement.

According to a sixth aspect of the present disclosure there is provided a method of determining a sampling rate for recording a subset of electronic auction activities, the method comprising; receiving an indication of an available data capacity of a data warehouse; retrieving recorded metrics data based on electronic auction activities communicated between a server and one or more ad exchanges; estimating a size of an auction activity as recorded by the server; applying one or more respective test sampling rates to the retrieved metrics data in order to obtain a respective one or more subsets of the metrics data; based on the estimated size of an auction activity, estimating a data size of each of the one or more subsets of the metrics data, such that each estimated data size of the one or more subsets of the metrics data is associated with a respective one of the test sampling rates; selecting the estimated data size of the one or more subsets of the metrics data suitable for the indicated available data capacity of the data warehouse; and in response to said selecting, determining that said sampling rate for recording a subset of electronic auction activities be set in dependence on the test sampling rate that is associated with the selected estimated data size.

The method may comprise transmitting to the server, an indication of the determined sampling rate, whereby the indication of the determined sampling rate causes the server to perform said recording a subset of electronic auction activities, the recorded subset of electronic auction activities being for storage at the data warehouse.

The selected estimated data size may be less than or equal to the indicated available data capacity of the data warehouse.

The method may further comprise transmitting a request to the data warehouse for storing a volume of data at the data warehouse, information defining the volume of data being provided in said request; and receiving a response from the data warehouse comprising the indication of an available data capacity of the data warehouse.

The response from the data warehouse may indicate that the data warehouse cannot accommodate the requested volume of data but can accommodate a reduced volume of data; wherein the response from the data warehouse may further include an offer of storing the reduced volume of data at the data warehouse; and wherein the method of determining the sampling rate for recording the subset of electronic auction activities may proceed in dependence on the offer being accepted.

### BRIEF DESCRIPTION OF THE DRAWINGS

FIG. 1 is a schematic of an advertising exchange system comprising a DSP.

FIG. 2 shows a flowchart that summarises a first embodiment of the process performed by the system of FIG. 1.

FIG. 3 shows a flowchart that summarises a second embodiment of the process performed by the system of FIG. 1.

FIGS. 4a-4c show a visual representation of an estimate of a storage capacity requirement for storing uncompressed auction events.

FIGS. 5a-5c show a visual representation of an estimate of a storage capacity requirement for cumulatively storing compressed auction events.

FIG. 6a is another visual representation of an estimate of a storage capacity requirement for cumulatively storing compressed auction events.

FIG. 6b is a visual representation of an estimate of a storage capacity requirement for storing auction events associated with a subgroup of users that access a particular service.

FIG. 7 is a visual representation of an RTB auction request.

FIG. 8 shows a flow of the main data communication transfers of the system of FIG. 1.

FIG. 9 shows a schematic representation of a DSP application server.

FIG. 10 shows a flowchart of an embodiment for configuring a data warehouse in advance of importing data to said data warehouse.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

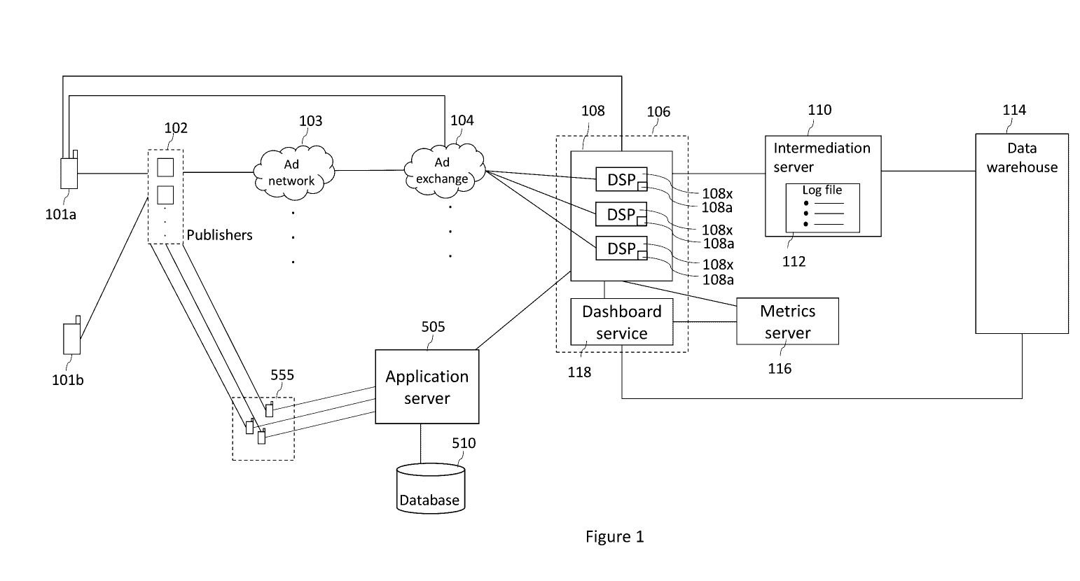

FIG. 1 illustrates a system 100 for predicting the amount of storage capacity required to store auction event data at a data warehouse, in accordance with an embodiment of the present disclosure. In one embodiment, each of multiple user terminals 101 are operated to run applications. The user terminal 101 may comprise desktop computers, laptops, mobile devices, PDAs. The applications may include applets that are integrated into other applications (e.g. an Internet browser), and dedicated applications in their own right. For clarity, only the full set of connections for user terminal 101a is shown in FIG. 1. As is known in the art, when the user terminals 101 are connected to a wide area network (WAN) such as the internet (not shown in FIG. 1), the applications can automatically send RTB ad calls (auction requests) via the WAN to publishers 102. The publishers 102 forward details of the requests they receive via an advertising network 103 and ad exchange server 104. The ad exchange server 104 itself then sends details of all of the received requests to multiple remote Demand Side Platforms (DSPs) 108. For convenience, FIG. 1 shows only one ad network 103 and one ad exchange 104, although the skilled person would understand that publishers can forward requests to different ad networks, and the DSP 108 can communicate with multiple ad exchanges simultaneously. Examples of known ad exchanges and which are referenced again later in this disclosure include: Google™, MoPub™, Nexage™, PubMatic™, Rubicon™, and Smaato™.

FIG. 1 depicts one DSP 108 that is associated with the present disclosure. The DSP 108 is located on a publicly accessible network, shown represented by the dashed line 106. In embodiments, the DSP 108 consists of multiple, typically twenty to thirty, servers referred to hereinafter as DSP application server(s) 108x. In alternative embodiments, the DSP 108 may be implemented as part of a private network.

The DSP 108 can receive hundreds of thousands or potentially millions of ad requests from ad exchanges every second. The requests are received at a load balanced single entry point for the DSP 108 so that the requests are distributed among the multiple DSP application servers 108x. Each ad exchange 104 can connect to multiple DSP application servers 108x. Each DSP application server 108x may connect to a single ad exchange 104 at a time providing a 1:1 relationship between DSP application server 108x and ad exchanges 104. Therefore in this case it may be said that each ad exchange 104 has an independent collection of DSP application severs 108x. Alternatively, each DSP application sever 108x may connect to multiple different ad exchanges simultaneously.

Because the DSP 108 platform is load balanced, the number of DSP application servers 108x can be dynamically changed or automatically scaled based on load i.e. the volume of RTB auction requests that are received from an ad exchange. That is if the number of incoming RTB requests increases the number of DSP application servers 108x used to receive those requests can be increased accordingly in order to distribute the load. Similarly, if the number of RTB requests decreases, the number of DSP application servers 108x needed can be reduced accordingly. The load on each DSP may also be controlled so that load is evenly distributed across the DSPs.

Each RTB auction request comprises at least one identifier. In some embodiments the auction request comprises a set of data which will include an identifier which is able to identify the request. Typically the auction request will comprise a set of data.

In some embodiments, the data may comprise a cookie identifier (cookie ID) that is unique to a user and is associated with the ad exchange 104.

The set of data that makes up an RTB auction request may be sourced from one or more locations e.g. data store(s) (not shown in FIG. 1). The set of data included in an RTB auction request may further comprise various different data fields, for example but not limited to one or more user identifiers, the user's geographic location, the user's preferred language, an identifier for the application the RTB auction request has come from (e.g. a type of game).

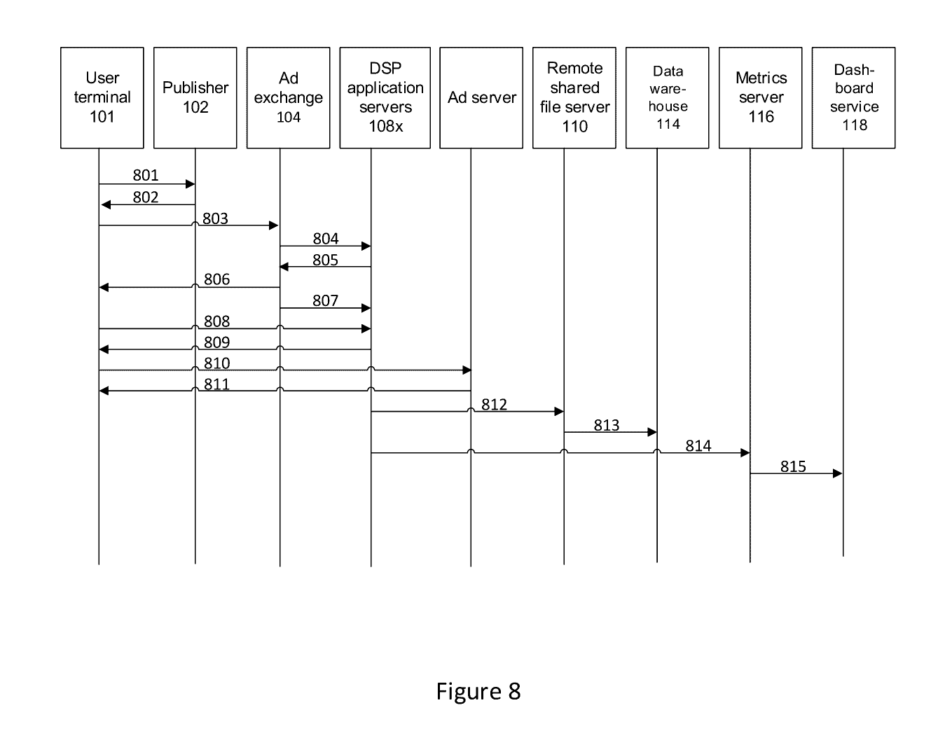

FIG. 7 shows a representative example of a single RTB auction request that is recorded by a DSP application server 108x as an auction “event” (described in more detail below). In this example, the auction request is shown as a data stream 700 headed by an RTB auction request identifier 701. The stream also includes a sequence of different data fields shown represented as A 702, B 703, C 704 and D 705. The person skilled in the art will appreciate that in embodiments, an RTB request may comprise more or fewer data fields than those shown in FIG. 7.

It should be noted that any one or more of the data fields (e.g. A, B, C or D) may be left empty, if for example there is no corresponding data currently available for the respective data field. Also, the user of the user terminal 101 can select to opt out of having one or more of the data fields being accessible by the DSP 108. In either of these cases, auction events can still be recorded but without including one or more of the data fields.

The DSP application servers 108x may be configured to filter the RTB requests based on one or more of the available data fields of the RTB auction requests. For example a DSP application server 108x may determine from the data fields a type of game that a user is playing. This information can be used to select an advert for a similar type of game that the user may be interested in playing.

As another example, the data fields may be filtered based on user ID so that the DSP application server 108x does not place bids too frequently in response to the received RTB auction requests. In this way the user is not constantly bombarded by advertisements. Similarly, filtering based on user ID can be useful so that the DSP application server 108x does not keep selecting the same ad content for a user.

As another example embodiment the data fields may be filtered by the user's language to ensure that adverts with content in the correct language (i.e. in the user's language) are selected and placed for that user.

For each request seen by a DSP server 108x, the DSP application server 108x must decide on behalf of an advertiser it is representing whether or not to make a bid for that opportunity to place an ad so that it is presented in the user's application. If a bid is placed, the DSP application server 108x sends the bid to the ad exchange 104 which processes the bids from other competitors that have also received the same advertising request. As with the RTB auction requests, each auction bid placed by the DSP application servers 108x includes one or more bid-specific identifiers. Each bid also includes the associated one or more auction request identifiers described above, so that every bid is linked to a corresponding RTB auction request.

The DSP application server 108x that places the winning bid (usually based on the highest price bid) is informed of the win by the ad exchange 104. Each win includes one or more win-specific identifiers. Each win also includes the associated one or more auction request identifiers and optionally the bid-specific identifier(s) as well, so that every win is at least linked to a corresponding RTB auction request. The winning advertiser thus gets their ad published to the user's application, usually in the form of a banner or a full page shown displayed on the user terminal 101 screen. The bids that are made may be part of a “second price auction” such that the advertiser that wins the auction actually ends up paying the second highest price bid for placing the ad in the user's application. Alternatively, the auction and the bids thereof can be of any suitable type of electronic auction as is known in the art.

Each of the DSP application servers 108x listen to all of the RTB requests they receive form the ad exchange. According to the present disclosure a sampling process of the received RTB requests is performed in real-time on the DSP application servers 108x. For example a 1:1000 sample rate is used, but it should be understood that other sample rates are possible.

For each of the 1:1000 sampled requests a respective data entry is stored in a record of the same DSP application server 108x. The DSP application server 108x also stores a data entry for every one of the bids made in response to a request, and a data record for every auction the DSP server 108x wins. Each of the recorded activities (the 1:1000 requests, bid responses and wins) are referred to hereinafter as auction “events”. Other types of activities may also be recorded as events. An event is more accurately defined as a line of data in a log file containing key textual information about the activity, where each activity is represented by one of said lines of data.

In embodiments, depending on the volume of incoming RTB ad requests, the sample rate can be dynamically adjusted as appropriate. For example if there is a relatively high number of incoming RTB ad requests, e.g. approximately one million ad requests received every second, then the sample rate may be lowered e.g. to 1:10,000 so that the amount of recorded event data for the auction requests does not overwhelm the system. Conversely, if there is a relatively low number of incoming RTB ad requests, e.g. 1,000 ad requests received every second, then the sample rate may be raised e.g. to 1:100. Other sample rates may be selected as appropriate based on the number of RTB ad requests received. For convenience, we refer to the 1:1000 sample rate throughout the remainder of the present disclosure. In embodiments the sample rate of a DSP application server 108x may be adjusted automatically by the DSP application servers 108x or may be adjusted manually by a user of the system 100.

The 1:1000 sampling is implemented at each of the DSP application server(s) 108x by software that forms part of a codebase for a respective DSP application server 108x. The recording of auction activities is achieved by using shared libraries. That is, existing shared libraries developed as part of a software toolset are implemented so that when stored auction events have been imported to the data warehouse 114 (as explained below), they can be read natively by the data warehouse 114.

Each of the DSP application servers 108x export their recorded event data to a third party remote shared file server 110, also known as an intermediation server, and located outside of the cloud 106, upon expiry of a predefined time interval. For example each of the DSP application servers 108x is configured to export their recorded event data every hour. Other time intervals may be defined for the DSP application servers 108x to export their recorded data.

In one embodiment, the DSP application servers 108x are configured to compress their recorded event data before exporting the event data to the remote shared file server 110. The compression method used may be any suitable compression algorithm known in the art. As one example, the “.gzip” file format which uses a solid compression technique to take advantage of the redundancy between the file data being compressed could be used. Further, the compression ratio used may be automatically adjusted on a regular basis. For example the compression ratio may be a function of the volume of event data that is recorded in one hour. For instance, if the volume of event data recorded by a DSP application server 108x in the past hour has fallen compared to the previous hour, the compression ratio used may be reduced by the DSP application sever 108x correspondingly i.e. so that the level of compression is reduced. Conversely, if the volume of event data recorded by a DSP application server 108x in the past hour has increased compared to the previous hour, the compression ratio used may be increased by the DSP application sever 108x correspondingly i.e. so that the level of compression is increased.

The export of the event data relieves the capacity requirements of the DSP application servers 108x so that the recorded event data can be stored persistently at the third party remote shared file server 110. When a DSP application server 108x exports its recorded event data to the remote shared file server 110 it does not stop monitoring and recording new auction activities. Instead, the DSP application servers 108x continue to record activities as event data which will then be exported to the remote shared file server 110 at the end of the next hour (or the end of the defined time interval). In one embodiment the remote shared file server 110 allows the storage and retrieval of any amount of data from anywhere on the Internet and the interaction with the DSP 108 and the data warehouse 114. An example of such a remote third party server 110 is the Amazon Simple Storage Service (Amazon S3) Web Services™ server.

The event data that is regularly exported by the DSP application servers 108x is stored at the remote shared file server 110 in the form of a log file 112. Every time the DSP application servers 108x export their event data to the shared remote file server 110, the events are added to the log file 112. The number of lines of data that make up the log file maintained by the remote shared file server 110 thus increases each time the DSP application servers 108x export their event data.

The remote shared file server 110 has a persistent network connection to the data warehouse 114. The data warehouse 114 is configured to import, on a regular basis, the log file 112 from the remote shared file server 110. In this way, the data warehouse regularly retrieves all of the event data that has been sent from the DSP application servers 108x to the remote shared file server 110 (i.e. data for the 1:1000 auction requests, every bid and every win). In one embodiment the data warehouse 114 imports the log file of event data into the data warehouse at the end of every twenty-four hour time interval. Other time intervals may be defined for the data warehouse 114 to import the log file 112. Once the log file 112 has been imported into the data warehouse 114, the event data subsequently exported from the DSP application servers 108x to the remote shared file server 110 will be stored in a new log file such that the new log file gets imported into the data warehouse 114 at the end of the next twenty-four hour time interval. This cycle of importing the current log file of event data into the data warehouse 114 at the end of the predefined time interval is repeated indefinitely. The data warehouse 114 then stores the event data for processing. Leveraging the auction event data at the data warehouse 114 is a useful tool for assessing what types of users are being presented with what adverts.

The advantage of exporting the event data from the DSP application servers 108x to the remote shared file server 110 is that the data warehouse 114 does not have to maintain a direct connection to the public cloud network 106 where the DSP 108 is located. Instead the data warehouse 114 can more conveniently maintain a private, persistent connection with the remote shared file server 110.

In embodiments, the auction event data recorded by the DSP 108 is assessed (e.g. from the records stored by the DSP application servers 108x and/or from the log file data imported into data warehouse 114), so that the DSP 108 can be configured to use this information to retarget appropriate ads for a user. For instance ads may be retargeted to certain ones of the devices (i.e. user terminals 101) and/or users who submit the RTB auction requests. As mentioned above, based on one or more of the data fields of recorded event data, appropriate ad(s) can be selected for users e.g. based on a type of game the user is playing and/or the user's language. The skilled person will understand that there will be many other ways of using the event data information for retargeting ads to specific devices and/or users.

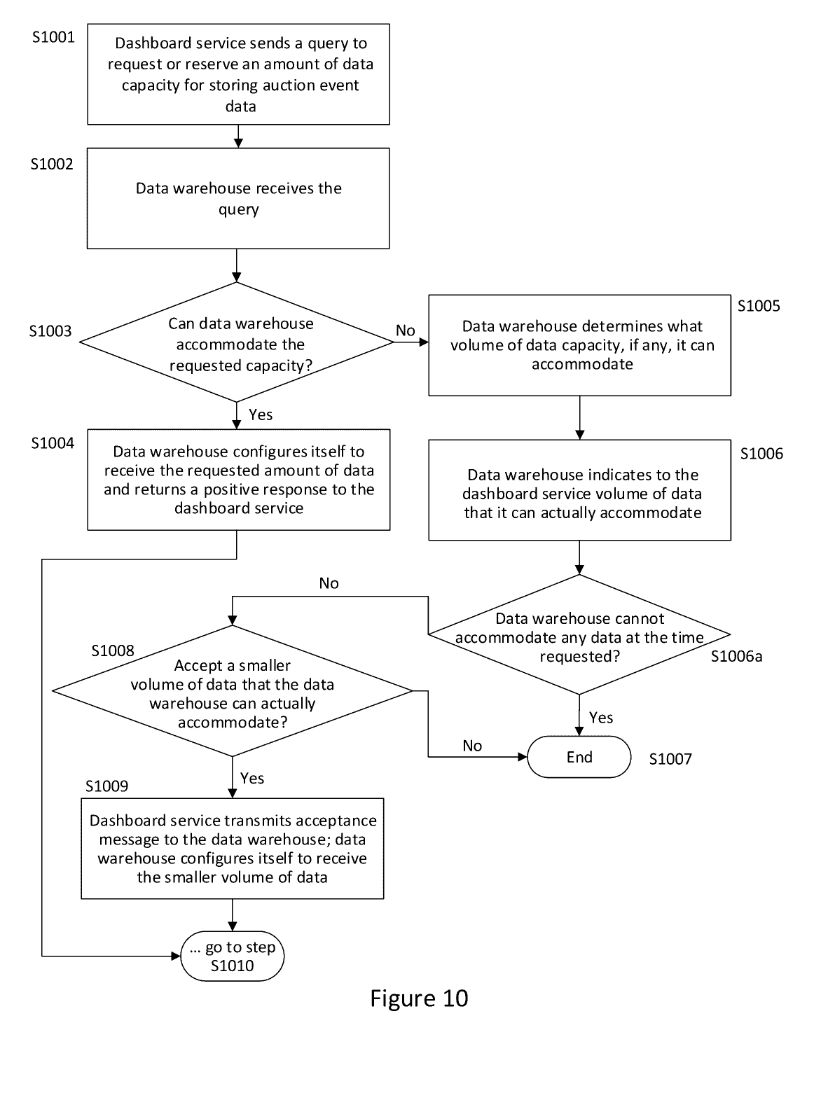

Returning to the DSP 108, each of the DSP application servers 108x have an associated software agent 108a running on a processor 901 (see FIG. 9) of the respective DSP application server 108x. The software agent 108a is configured to host a web page that utilises simple metric counters so that metrics about the behaviour of the DSP application server 108x are recorded. The respective web page is scraped every minute by a process run by the software agent 108a so that the software agent 108a collects the metrics from the DSP application server 108x that it is running on. The collected metrics for all of the DSP application servers 108x are aggregated and stored in a metrics server 116. Metrics server 116 may be located outside of public network 106 (as shown in FIG. 1), or it may be located on the same public network 106 as the DSP 108. The process of collecting and storing the metrics in the metrics server 116 is performed in parallel with the above described process of the DSP application servers 108x sampling RTB requests and recording auction activities as event data.

The collected metrics will typically include the number of auction requests seen, bid responses made, wins, and hundreds of other metrics describing the service provided by the DSP 108. The process of collecting the metrics may be implemented by extending the functionality of an open source monitoring framework to filter and collect relevant metrics before storing the collected metrics in the metrics server 116. An example of such a monitoring framework is Sensu®. The metrics may be filtered so that only relevant metrics that match with certain filter and/or parameters settings are collected and stored in the metrics server 116. In this way the metrics server 116 can store metrics in line with the types of event data that are recorded by the DSP application servers 108x.

The metrics are counted in real time and for all of the activities seen or performed by the DSP application servers 108x. That is, metrics are collected for all activities that come through the DSP application server 108x and not a sampled number as is the case described above when the DSP application servers 108x only store a data record for 1:1000 auction requests. Typically, the collected metrics that are stored in the metrics server 116 are automatically deleted from the metrics server 116 after a pre-determined period of time has elapsed, for example a period expiring after the next time the log file 112 of event data is imported into the data warehouse 114.

The metrics data stored in metrics server 116 is accessible by a dashboard service 118 running on a computing device (not shown in FIG. 1). FIG. 1 shows the dashboard service 118 as being located on the public network 106 that also hosts the DSP 108. Based on a query structure generated by the dashboard service 118, the dashboard service 118 retrieves metrics from the metrics server 116 in real time i.e. immediately. It should be noted that there can be one or more metrics servers 116 for storing the collected metrics. For convenience only one metrics server is shown in FIG. 1.

In embodiments, the dashboard service 118 can retrieve the stored metrics from multiple metrics servers by communicating the query to only one of the metrics servers which in turn can communicate with other metrics servers by proxy, such that all stored metrics from the multiple metrics servers can be retrieved by the dashboard service 118. Based on the query by the dashboard service 118, the metrics retrieved can be for specific types of activities seen by the DSP application servers 108x and for a particular time interval e.g. activities seen over the past day. Alternatively, the time interval may span a period covering a new ad campaign by advertisers so that the metrics retrieved cover auction activities seen during the new campaign. The skilled person will understand that other particular periods of interest may be defined. Further, the query causes the dashboard service 118 to use the retrieved metrics to determine an estimated volume of storage capacity that will be required by the data warehouse 114 when the next log file 112 of event data is imported into the data warehouse 114. By having advance knowledge of a predicted level of storage capacity that will be required by the data warehouse 114, the data warehouse can be configured appropriately thus maximizing its performance.

The step of determining an estimated volume of storage capacity is based in part on an assumption of the size of an event (i.e. one line of data in the log file 112). Although there will be some variation in the size of each event depending on the amount of data comprised within that event, the dashboard service 118 makes an assumption that each event in the log file 112 is one size. In one embodiment the dashboard service assumes that each of the events are the largest size event it would expect to see. Typically the largest size of an event would be expected to be around 2 KB (2 kilobytes). In the present disclosure reference is made to the largest size event that would be expected, although in alternative embodiments the assumed one-size of the auction events may be based on other determining methods, e.g. mean, median or modal size. In another embodiment the dashboard service 118 determines an average size of an event but for each event type i.e. determining one size for auction request events, one size for bid response events, and one size for auction win events. As before, the one-size for the auction events of each type may be based on other determining methods e.g. largest, mean, median or modal size. Any combination of these different determining methods could be used for each event type e.g. in one example scenario the one-size for auction request events could be based on a mean size of auction request events, while the one-size for bid response events could be based on the largest expected size of a bid response, and the win events could be based on mean size of win events.

Throughout the disclosure, when describing the amount of the estimated data in number of bytes, we use the binary prefixes kibi (Ki, 1024 bytes), mebi (Mi, 1024² bytes) and gibi (Gi, 1024³ bytes). The estimated amount of data could also be estimated using decimal prefixes i.e. kilobyte (KB, 1000 bytes), megabyte (MB, 1000² bytes) and gigabyte (GB, 1000³ bytes). The dashboard service 118 can also communicate with the data warehouse 114 to assess the size of events in recently imported log files. This way the dashboard service 118 can make a more educated estimate of the largest size of an event. By using the largest expected size of an event in determining the estimated volume of storage capacity required by the data warehouse, the data warehouse 114 is given a buffer over the actual amount of space that will actually be required i.e. because some events will be smaller than the estimated largest size used in the determining method.

When the largest size of an event that would be expected has been estimated, the dashboard service 118 utilises the retrieved metrics and knowledge of the sampling rate used by the DSP application servers 108x (e.g. 1:1000) to determine the estimated volume of storage capacity required by the data warehouse 114 to store the auction events that have been recorded over the past day (or other defined time interval).

In one embodiment the dashboard service 118 will estimate the raw log file space required throughout the past day by using the metrics retrieved for the past day (or other defined time interval) and multiplying the number activities seen (requests, bid responses and wins) by the estimated size of an event. In alternative embodiments, rather than performing a multiplication, one or more other operations can be performed, based on the number of activities seen and the estimated size of an event, to determine the estimate of the log file space required.

The dashboard service 118 has knowledge of the 1:1000 sampling rate used for recording the subset of auction requests, and so will scale the metric value of requests seen by a corresponding amount. That is, if the metrics server 116 has collected and aggregated 400,000 auction requests for instance over a particular time interval, then the dashboard service will use the 1:000 sampling rate to determine that there are only 400 request events that get exported to the remote shared file server 110 for that time interval. Purely as an example, if, for a particular time interval, the dashboard service 118 deems that there are 400 requests, 200 bid responses and 100 wins, then the dashboard service 118 determines that there are a total of 700 events (400+200+100=700). The dashboard service 118 then uses the estimated largest size of an event e.g. 2 KB, and multiplies this value by 700 to determine the estimated total size of all the events over said particular time interval i.e. “2 KB×700”=1,400 KB. Thus an estimated value of the raw data size of events covering a particular time interval is generated. This data size estimate is equivalent to an estimate of the storage capacity required by the data warehouse 114 for storing the events from that particular time interval. This estimate of required data capacity can be communicated to the data warehouse in real time to configure the data warehouse 114 in advance of the next time it imports the raw log file event data from the remote shared file server 110. The data warehouse 114 can therefore anticipate the amount of data that it will receive at the next import, which improves the efficiency of the import process and the processes subsequently performed by the data warehouse 114. The estimated storage capacity requirement can also advantageously be analysed at the dashboard service 118 to forecast financial costs of storing data at the data warehouse 114, based on the amount of data that is going to be imported and stored there.

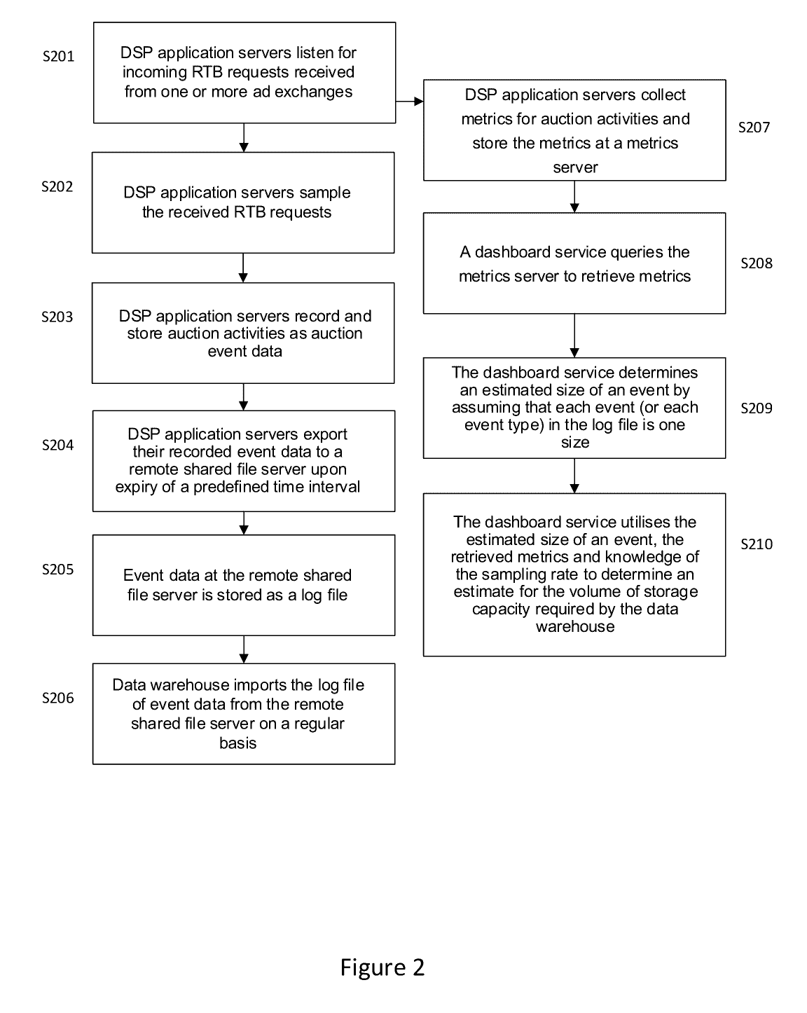

FIG. 2 shows a flowchart that summarises the process 200 performed by the system 100. The process 200 starts at step S201 with the DSP application servers 108x listening for incoming RTB requests received from one or more of the ad exchanges 104.

At step S202 each DSP application server 108x samples in real-time the RTB requests it has received.

At step S203 the DSP application servers 108x record and store the auction activities (the sampled requests, plus bid responses and wins) as auction event data.

At step S204 the DSP application servers 108x export their recorded event data (optionally compressed) to the remote shared file server 110 upon expiry of a predefined time interval e.g. every hour.

At step S205 the event data exported to the remote shared file server 110 is stored in the form of a log file 112.

At step S206 the data warehouse 114 imports the log file of event data from the remote shared file server 110 on a regular basis e.g. every 24 hours.

After step S201 (above), the process 200 branches whereby step S207 is performed in parallel to the steps S202 to S206 described above. At step S207 the software agents 108a running on the DSP application servers 108x each collect metrics for auction activities and stores the metrics at metrics server 116.

Then at step S208 the dashboard service 118 queries the metrics server 116 to retrieve metrics recorded over a time interval defined in a query structure. At step S209 the dashboard service 118 determines an estimated size of an event wherein the dashboard service 118 assumes that each event in the log file 112 (or each type of event in the log file 112) is one size.

Finally at step S210 the dashboard service 118 utilises the estimated size of an event, the retrieved metrics and knowledge of the sampling rate used by the DSP application servers 108x to determine an estimate for the volume of storage capacity required by the data warehouse 114.

In one embodiment the system 100 can also predict the amount of storage capacity required to store auction event data at the data warehouse 114 but only if the user of the application that initially made the RTB auction request (RFB) is a user of a particular subgroup of users, shown represented as subgroup 555 in FIG. 1. For example the subgroup 555 are users of one or more applications that are associated with a particular service. For example the service may be a gaming service for game applications. The game applications may be downloaded from one or more application server(s) 505 of the service and/or interact with the application servers when a game application is run on a user's user terminal 101. A game application may access the server 505 in order to communicate over the Internet (WAN) with other players of the applications associated with the gaming service, to download updates, access new content and/or store information about a player's profile and/or preferences. The devices and/or users of the gaming service may also be registered at server 505 and their details may be stored for example in a database 510 also associated with the gaming service. The skilled person will realise that there may be many other reasons for an application to access the server(s) 505 than those mentioned. Also, although referred to as a gaming service, the particular service may be a service other than a gaming service, and the applications may be applications other than game applications.

In embodiments the server(s) 505 are associated with the proprietor of the DSP 108, meaning that it can be in that proprietor's interests to monitor the data of auction events (requests, bid responses and wins) specifically in relation to the users that make up the subgroup 555. For example, by assessing the identifiers of the auction event data recorded by the DSP 108 (e.g. from the records stored by the DSP application servers 108x and/or from the log file data imported into data warehouse 114), the DSP 108 can use this information to retarget appropriate ads for a user, as described above. For instance ads may be retargeted to certain ones of the devices and/or users of the subgroup 555. As mentioned above, based on one or more of the data fields of recorded event data, appropriate ad(s) can be selected for users e.g. based on a type of game the user is playing and/or the user's language. The skilled person will understand that there will be many other ways of using the event data information and identifiers for retargeting ads to specific devices and/or users that make up the subgroup 555.

As mentioned above, RTB auction requests (RFB) comprise various unique device and/or user identifiers. When an auction request is made by an application from a user terminal 101 of a user of the subgroup 555, the request contains one or more identifier(s) to indicate whether the device, the user, or both are an active or lapsed member of a particular service associated with that subgroup 555. Other such identifiers specific to other services can be included in the auction request. Identifiers of this type are commonly referred to as Identifiers For Advertisers (IFAs). It should be noted that the full set of connections between to and from user terminals that make up subgroup 555 are not shown in FIG. 1, for the sake of clarity. However, it should be understood that the user terminals of subgroup 555 also interact with the DSP 108 and the ad exchange in the same as shown for user device 101a in FIG. 1. When the auction request has been forwarded by the ad exchange and received at the DSP 108, the DSP servers 108x that listen to all of the incoming auction requests can monitor for any requests that contain one or more IFAs. The DSP servers 108x are configured to conduct a matching process by comparing all observed IFAs against a database (for example, the database 510) that has previously accumulated encrypted IFAs for all devices and/or users of subgroup 555 registered to the gaming service.

The database 510 is accessible by the DSP application servers 108x and may be located on network 106. Alternatively, the database 510 may be located elsewhere on the WAN, remote from network 106, as shown by the example in FIG. 1. In embodiments the database may be directly accessible by the software agent 108a running on the respective DSP application server 108x. Alternatively, the software agent 108a running on the respective DSP application server 108x may have to access the database 510 via application server 505, as shown by the example in FIG. 1. The software agent 108a sends a query to the database 510 (or application server 505) to see if there are any matching identifiers (IFAs) stored at database 510. The DSP application server 108x receives a response back from the database 510 (or application server 505) and will determine whether there is a match. If there is a match, then that DSP server 108x records a metric for the match (“match” metric). Any “match” metrics are collected from all of the DSP application servers 108x every minute as part of the scraping process and aggregated for storage in the metrics server 116, along with the other metrics. As described above, the metrics may be filtered so that only metrics that meet certain filter and/or parameters settings are stored in the metrics server 116. Therefore in response to a user-submitted query, the dashboard service 118 can retrieve the “match” metrics as part of the retrieval of all of the stored metrics. The dashboard service is therefore provided with an indication of how many of the users that make up subgroup 555 are ‘seen’ by the DSP 108 over the particular time period defined in the query (e.g. the past 24 hours).

To predict the amount of storage capacity required to store just the auction events associated with the users that make up subgroup 555, the dashboard service 118 assesses the retrieved metrics to determine the total number of auction activities that have occurred over the past defined time interval (a combination of 1:1000 auction requests, every bid response and every win). Using the total number of these activities and the total number of “match” metrics, a ratio between the two numbers is determined by the dashboard service 118 to provide an estimate of the number of events that have been recorded over the time interval, but specifically for the users that make up subgroup 555:
Σmetric activities:Σ“match” metrics

The dashboard service 118 then uses the estimated largest size of an event (e.g. 2 KB), and multiplies this value by the result of the ratio to determine the estimated total size of all the events over said particular time interval but only in relation to users that make up subgroup 555. Thus an estimated value of the raw data size of events covering a particular time interval, and associated only with users that make up subgroup 555, is generated. This data size estimate is equivalent to an estimate for the storage capacity required by the data warehouse 114 for storing the events from that particular time interval, and that are associated only with users that make up subgroup 555. As before, this estimate of required data capacity can be analysed by the dashboard service 118 and communicated by the dashboard service 118 to the data warehouse 114 so that the data warehouse 114 can be configured in advance of the next import of the raw log file event data from the remote shared file server 110. As noted above, in alternative embodiments, rather than performing a multiplication, one or more other operations can be performed, based on the result of the ratio and the estimated size of an event, to determine the estimate of the log file space required in relation to users that make up subgroup 555.

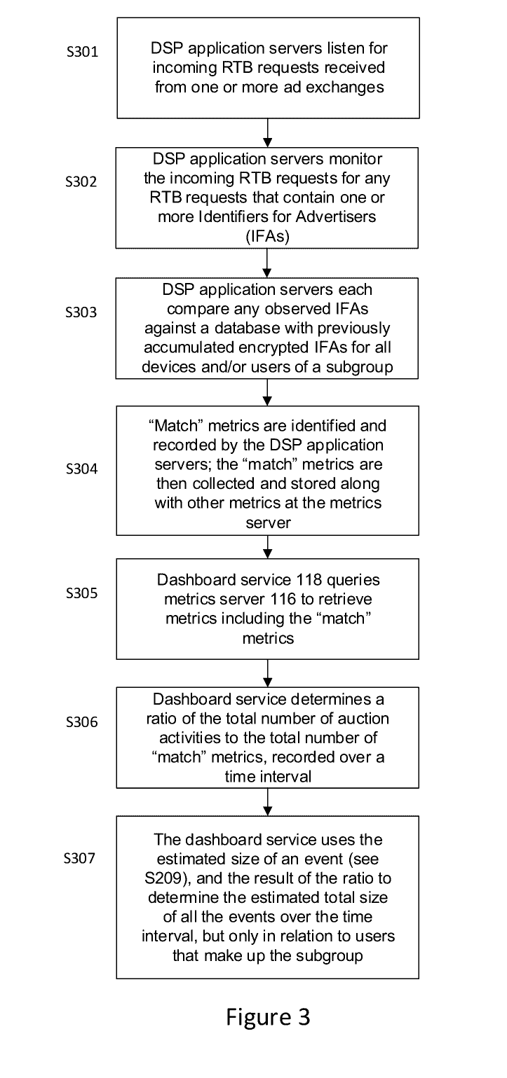

FIG. 3 shows a flowchart that summarises the process 300 of the alternative embodiment performed by the system 100, whereby an estimate of the log file space required in relation to users that make up a particular subgroup of users i.e. subgroup 555. It should be noted that the steps of process 300 can be implemented as part of the process 200; therefore some of the steps of process 300 are the same as and/or make reference to the steps of process 200.

The process 300 starts at step S301 with the DSP application servers 108x listening to incoming RTB requests received from one or more of the ad exchanges 104 (the same as step S201).

At step S302 the DSP application servers 108x monitor the incoming RTB requests for any RTB requests that contain one or more Identifiers for Advertisers (IFAs). At step S303 the DSP application servers 108x each utilise their software agent 108a to communicate with the database 510 (optionally via application server 505) to compare any observed IFAs against previously accumulated encrypted IFAs stored at database 510, for all devices and/or users of subgroup 555.

At step S304, “match” metrics are identified and recorded by the DSP application servers 108x. The “match” metrics are then collected and stored along with other observed metrics at the metrics server 116 (as part of step S207 above).

At step S305 the dashboard service 118 queries the metrics server 116 to retrieve metrics including the “match” metrics (as part of step S208 above).

At step S306 the dashboard service 118 determines a ratio of the of total number of auction metric activities to the total number of “match” metrics recorded over the time interval, thus providing an estimate of the number of events that have been recorded over the time interval, but specifically for the users that make up the subgroup 555.

At step S307 the dashboard service 118 uses the estimated size of an event (see step S209 above), and the result of the ratio to determine the estimated total size of all the events over the time interval, but only in relation to users that make up the subgroup 555. Thus an estimated value of the data size of events covering a particular time interval, and associated only with the users that make up the subgroup 555, is generated.

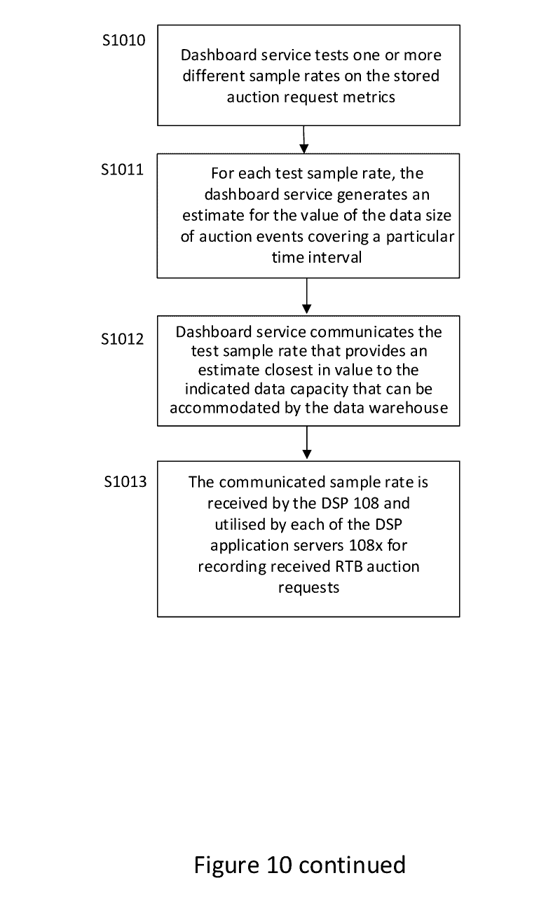

In alternative embodiments, in advance of the data warehouse importing the event data log file, the dashboard service 118 may communicate with the data warehouse 114 to request a certain amount of data capacity for storing auction event data captured over a particular time interval. Such a scenario is summarised by the flowchart 1000 shown in FIG. 10. For example, at step 1001, a user may utilise the dashboard service 118 to send a query to the data warehouse 114 to request or reserve an amount of data capacity for storing auction event data over an upcoming period of time. Alternatively, the dashboard service 118 may be configured to automatically send a query to the data warehouse 114. The time period specified in the query may be predefined or set by the user.

The data warehouse receives the query at step 1002 and then analyses its available resources to see if it can accommodate the requested capacity at step 1003. In response, the data warehouse 114 will indicate to the dashboard service 118 whether or not it can accommodate the volume of data capacity requested to be stored. If the data warehouse 114 determines that it can accommodate the requested volume of data capacity, then at step 1004 the data warehouse configures itself to receive the requested amount of data and returns a positive response to the dashboard service 118. The data warehouse 114 may configure itself by bringing one or more memory stores online in anticipation of receiving the requested amount of data that is imported from the remote shared file server 110.

Alternatively, if the data warehouse 114 determines that it cannot accommodate the requested volume of data capacity, then at step 1005 it will determine what volume of data capacity, if any, it can accommodate and sends this back as an indication to the dashboard service 118 (step 1006). If the data warehouse cannot accommodate any data at all at the time requested (step 1006a), then the process ends at step 1007.

For example, the dashboard service 118 query may include a request for 5 GB of data storage capacity. Based on the query, the data warehouse 114 may determine that it cannot possibly accommodate this level of data and in response reports back to the dashboard service 118 that it cannot accommodate the volume of data requested but that a smaller volume of data could actually be accommodated. At step 1008 the user of the dashboard service 118 can decide whether or not to accept the smaller volume of data that the data warehouse can accommodate. Alternatively this decision may be made automatically by the dashboard service 118. If the user (or the dashboard service 118) decides not to accept the smaller amount, the process ends (step 1007). If the user (or the dashboard service 118) accepts the smaller volume of data, then at step 1009 the dashboard service 118 transmits an acceptance message to the data warehouse 114 which may configure itself as appropriate in advance of importing the accepted smaller volume of data from the remotes shared file server 110. For example the data warehouse 114 may bring the required amount of storage capacity online in anticipation of receiving the imported data. If the process was ended at step 1007, then the user of the dashboard service 118 may start the process over by making a new query (step 1001).

At step 1010, based on the amount of capacity that can actually be accommodated by the data warehouse 114, the dashboard service 118 adjusts the known sampling rate for sampling the received RTB auction requests e.g. the 1:1000 sample rate, in order to test one or more sample rates and apply them to the stored auction request metrics data. At step 1011, the dashboard service 118 then uses an estimated one-size for an event, e.g. 2 KB (as described above), and for each test sample rate used, multiplies this value by the total number of determined auction events. Thus multiple estimates for the value of the data size of events covering a particular time interval may be generated. Therefore the test sample rate as used by the dashboard service 118 that provides an estimate closest to the data capacity value that can be accommodated by the data warehouse 114 is communicated by the dashboard service 118 to the DSP 108 (step 1012). At step 1013, the communicated sample rate received by the DSP 108 is then utilised by each of the DSP application servers 108x. In this way, the volume of auction event data (i.e. sampled auction requests, all bid responses and all bid wins) that gets imported into the data warehouse 114 will be in the region of the capacity available at the data warehouse 114. The recorded event data is then exported to the remote shared file server 110 and subsequently imported by the data warehouse 114 (as detailed in the above embodiments).

The above described method from step 1010 may also be applied in the following alternative embodiment. The dashboard service 118 may receive an indication about a current capacity constraint or limitation of the data warehouse 114. Although this step is not explicitly shown in FIG. 10, it is akin to step 1006 where the data warehouse 114 indicates to the dashboard service 118 the volume of data that it can actually accommodate. Purely as an example, the data warehouse 114 may indicate to the dashboard service 118 that it has the capacity to store data from the DSP platform 108 at a rate of 100 GB per day (twenty-four hours). With this information, the dashboard service 118 works as described above to apply one or more test sample rates to the retrieved metrics data (step 1010) in order to generate a respective one or more estimates for the value of the data size of events covering the time interval (i.e. twenty-four hours in this example) (step 1011). The dashboard service 118 selects and communicates to the DSP platform 108 the test sample rate that provides the estimated data size of events that is suitable for (e.g. closest in value to) the indicated data capacity limit of the data warehouse 114 (i.e. 100 GB in this example) (step 1012). The DSP application servers 108x can then use the communicated sample rate as the sample rate for recording the received RTB auction requests.

At some stage, the rate at which RTB auction requests are received by the DSP platform 108 may change, but the current capacity constraint of the data warehouse 114 remains in place. For example, an increase in the rate of receiving RTB requests may occur at peak times of internet usage (e.g. potentially during evenings and weekends). As another example, an increase in the rate of receiving RTB requests is likely if a DSP application server 108x connects to more than one ad exchange 104.

Therefore in situations where the overall volume of auction activities at a DSP application server 108x has increased, the sampling rate for recording the RTB auction requests will need to be reduced. This is so that the volume of events data for the recorded events can be maintained as close as possible to the rate according to the constraint of the data warehouse 114 i.e. in this example the 100 GB per day.

In practice, the reduced sampling rate for recording the RTB auction requests is automatically determined by the dashboard service 118 re-applying steps 1010 through 1012 (as described above) but using the most up-to-date metrics data. For instance, the dashboard service 118 may be configured so that it can constantly detect changes in the stored metrics data, and in response, automatically apply one or more updated test sample rates to the auction request metrics data (e.g. lower sample rates so that fewer auction requests are recorded). The dashboard service 118 can then select the appropriate test sample rate that provides the estimated data size of events that is closest in value to the indicated data capacity limit of the data warehouse 114. The selected updated sample rate is then communicated by the dashboard service 118 to the DSP platform 108 and used by the DSP application servers 108x. Thus the sample rate for recording the RTB auction requests is automatically adjusted so that the volume of recorded events data is always maintained as close as possible to the indicated capacity limit of the data warehouse 114.

Although the above example refers to reducing the sampling rate for recording RTB auction requests, the inverse situation is also possible: i.e. if the volume of auction activities at a DSP application server 108x decreases, then the sampling rate for recording RTB auction requests may be increased (i.e. to record more auction requests) so that the volume of recorded events data is maintained as close as possible to the capacity limit of the data warehouse 114.

In embodiments it may be desirable for the recorded events data not to exceed the capacity limit of the data warehouse 114 (e.g. the 100 GB in the above example). In this regard, the dashboard service 118 may be configured so that it always selects the test sample rate that provides an estimated data size of events that is closest in value to, but does not exceed, the indicated capacity limit of the data warehouse 114.

In further embodiments the indicated current capacity constraint or limitation of the data warehouse 114 may be updated at anytime. The dashboard service 118 reacts accordingly to re-apply the steps 1010 through 1012. That is, the dashboard service 118 will apply one or more new test sample rates to the auction request metrics data, so that it can select and communicate to the DSP platform 108 the test sample rate that provides an estimated data size of events that is closest in value to the updated indicated data capacity limit of the data warehouse 114.

In embodiments of the present disclosure, when the DSP application servers 108x are configured to compress their recorded event data (as described above), then the dashboard service 118 can also estimate the level of compression employed by the DSP servers 108x. This allows the dashboard service 118 to ultimately estimate the storage capacity requirement of the data warehouse 114 for storing the compressed event data.

The dashboard service 118 estimates the level of compression based on the number of auction activities over a period of one hour, as determined from an analysis of the metrics data retrieved from the metrics server 116. For example the dashboard service 118 knows that the compression ratio applied to the recorded event data may be adjusted by the DSP application servers 108x on an hourly basis. Therefore in response to the number of metrics for all of the activity types over a one hour period, the dashboard service 118 can estimate the compression ratio that will be applied by the DSP application servers 108x to the corresponding recorded events. The estimation of the compression ratio can be performed separately for each hour's worth of metrics retrieved from the metrics server. Thus when the number of metrics increases or decreases across one particular hour, a higher or lower compression ratio is estimated accordingly and which is used to scale the estimated storage capacity requirement for storing auction events that have been recorded in that particular hour. Thus an estimate for the storage capacity requirement of the data warehouse 114 for storing the compressed event data over the past day (or other predefined time period) is achieved.

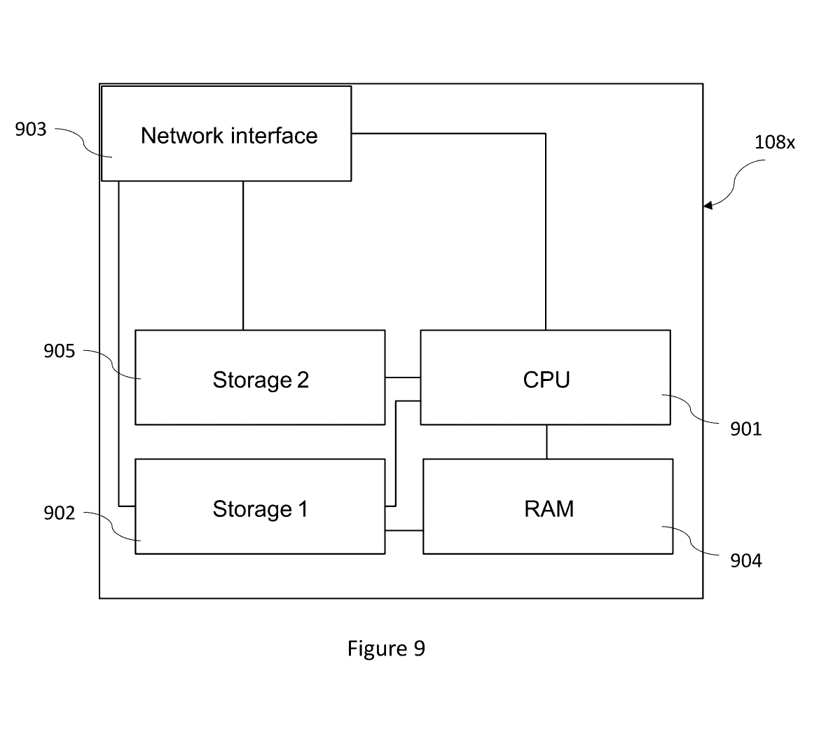

FIG. 8 depicts a visual flow of the main data communication transfer steps performed by the system 100.

At step S801, a user of the user terminal 101 uses an installed web browser or application to navigate to a website or access a service associated with a publisher 102. At step 802, a publisher web server sends back code, usually in the form of HTML code although other code language types may be used. The code returned to the browser (or application) indicates a publisher ad server that the browser can access to download a further HTML code comprising a coded link known as an ad tag. The ad tag points the user terminal to the RTB enabled ad exchange 104 and causes the user terminal 101 to pass on information about the publisher's ID, the site ID and ad slot dimensions when an ad request is made.

At step 803 an RTB request for bid (RFB) is generated by a processor of the user terminal 101 and sent directly over the WAN to the ad exchange 104.

At step 804 the ad exchange commences the RTB auction procedure by forwarding the received requests to the DSP application servers 108x.

The DSP application servers perform the process to sample the received auction requests (e.g. 1:1000) and wherein the sampled requests are recorded as event data. As described above, the DSP application servers 108x also record events for all of the other activities that are seen by the DSP application servers, including bid responses and wins.

The DSP application servers 108x use the retrieved user data information and the publisher information in the originally received auction request to make an informed decision on whether to place a bid (bid response). The bid data comprises one or more of the associated auction request identifiers plus bid-specific identifiers as described above. The bid also includes a DSP redirect for the user terminal 101, should the bid win the RTB auction. The bid data is communicated by the DSP application server 108x back to the ad exchange 104 (step 805).

At step 806 the ad exchange 104 selects the winning bid and passes the DSP redirect to the user terminal 101 associated with the winning bid. The DSP application server 108x is also informed of the win where a win event is recorded (step 807). The win event includes one or more win-specific identifiers plus the associated one or more auction request identifiers, and optionally the bid-specific identifier(s) as well.

At step 808 the user terminal 101 directly calls the DSP 108 using the DSP redirect received at step 806. By return the DSP 108 sends to the user terminal 101 details of the winning advertiser's ad server by way of an ad server redirect at step 809. The user terminal 101 uses the ad server redirect to call the ad server at step 810, and in response the ad server serves the final advertisement (e.g. banner, window, full screen ad) for presentation in the bowser (or application) at the user terminal 101 at step 811.

At step 812, after the sampled auction requests, plus all observed bid responses and win activities have been recorded as events at the DSP application servers 108x, the DSP application servers 108x routinely export the event data to the remote shared file server 110. In turn, at step 813, the data warehouse 114 is configured to import the log file of event data from the remote shared file server 110.

In parallel with the steps of recording the auction activities as auction events, the DSP application servers 108x collect metrics for all of the observed auction activities and stores them in metrics server 116 (step 814). The collected metrics may optionally be filtered as described above.

After metrics data has been stored at the metrics server 116, the dashboard service 118 accesses the stored metrics from metrics server 116 at step 815. The dashboard service 118 processes the retrieved metrics data in order to determine an estimated volume of storage capacity required by the data warehouse 114 i.e. for storing the to-be-imported event data from the remote shared file server 110.

Referring to FIG. 9, an example schematic representation of a DSP application server 108x is shown. The DSP application server 108x comprises one or more central processing unit(s) (CPU) 901 for performing the processes of the DSP application server 108x as described throughout the present disclosure. The CPU 901 is connected to a first local memory store 902 that stores software instructions which are run by the CPU 901. The software instructions include the instructions required by the CPU 901 to perform the steps of sampling the received auction requests and filtering the data fields of the RTB auction requests. The software instructions also enable a network interface or port 903 to send and receive messages and data, for example over the WAN, to and from the various other entities the DSP application server 108x communicates with e.g. the user terminals 101, ad exchanges 104, dashboard service 118, metrics server 116, remote shared file server 110, application server 505 and database 510.

The DSP application server 108x also comprises Random Access Memory (RAM) 904 that loads the software instructions to be run on the CPU 901. When the software is run by the CPU 901 this forms the software agent 108a as depicted running on DSP application server 108x in FIG. 1. The DSP application server 108x also comprises a second local memory store 905 that temporarily stores the auction events data prior to exporting them to the remote shared file server 110. Alternatively, the DSP application server 108x may only have a single memory store, e.g. local memory 902, which can be shared or split between both the stored software and the stored auction events data. The incoming set of data making up an RTB auction request is received at the network interface 903. The CPU 901 processes the received data, and compiles it into an auction request event which is stored in the local memory store (i.e. 902 or 905). The CPU 901 can also be configured so that it performs the step of exporting the stored event data to the remote shared file server 110 upon expiry of a programmable time interval.

As part of the process of determining an estimated volume of storage capacity required by the data warehouse 114, the retrieved metrics can be processed by a processor at the dashboard service 118 and rendered as graphs on a visual display unit (not shown), thus providing a visual representation of the volume of storage capacity required. The graphs can also rendered based on user-defined settings. For example a user of the dashboard service 118 can set the scale of the graph axes and the units used for the axes so as to dynamically scale the rendered graph as desired. The user can change these settings at any time so that the graph is dynamically updated in real time.

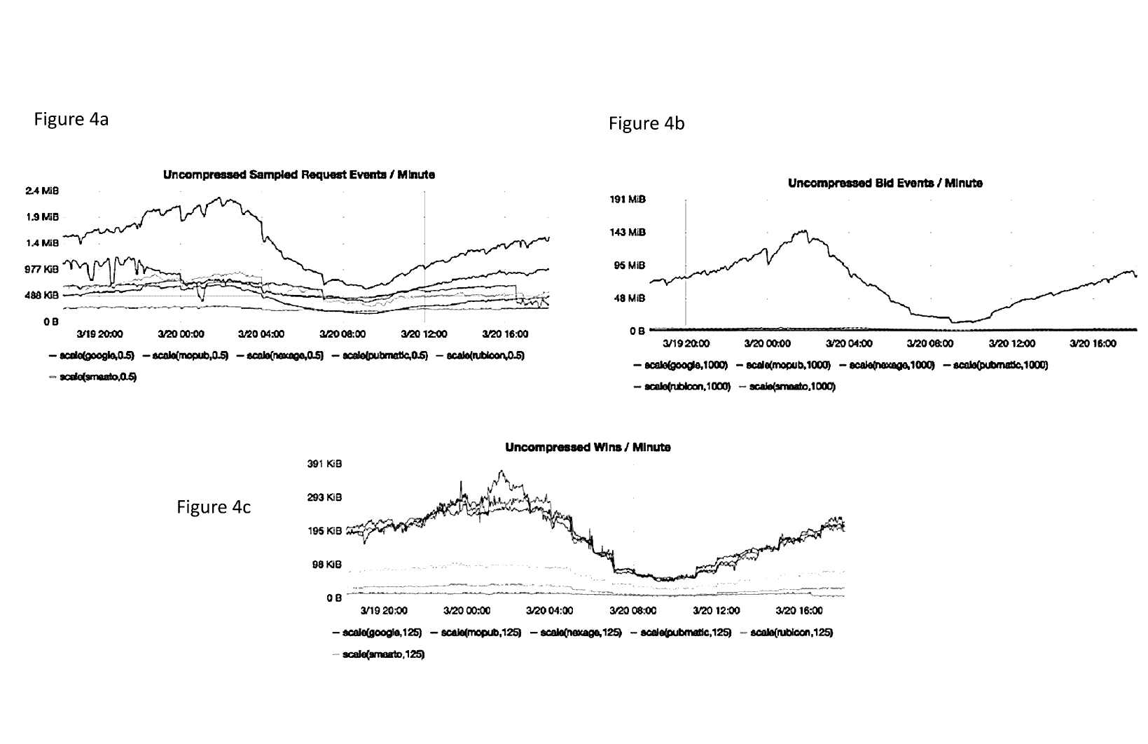

FIGS. 4 to 6 show example graphs rendered according to user-defined settings so that the retrieved metrics provide a visual indication of the estimated storage capacity that will be required at the data warehouse 114. The x-axis represents elapsed time, from 18:00 on 19 March to 18:00 on 20 March, which is scalable down to a resolution of one minute; the y-axis shows the determined estimate of the storage capacity requirement.

The three graphs 4a, 4b and 4c in FIG. 4 all depict the behaviour of auction activities at the DSP 108 with six different ad exchanges throughout the past day (24 hours) on a per minute resolution (the six different ad exchanges in these examples are: Google™, MoPub™, Nexage™, PubMatic™, Rubicon™, and Smaato™). FIG. 4a depicts the estimate of storage capacity for uncompressed auction request events only; FIG. 4b depicts the estimate of storage capacity for uncompressed bid response events only; FIG. 4c depicts the estimate of storage capacity for uncompressed win events only. The graphs in FIGS. 4a and 4b both show that there has been far more activity with the ad exchange “Pubmatic™” as compared with the other ad exchanges. However FIG. 4c shows that in terms of “win” events, the estimated storage capacity requirement is more closely matched for the different ad exchanges 104. For the different types of events, the graph lines in FIGS. 4a to 4c show the estimated storage capacity requirement for every minute of the previous 24 hours. Consequently, the graph lines show a series of peaks and troughs e.g. peaks representing when there has been more activity so that a greater storage capacity will be required at the data warehouse 114 to store the events from this time. As would be expected, the estimated storage capacity required shown in graph 4b (for bid responses, in the order of MiB) is greater than that for graph 4c (for wins, in the order of KiB). This is because a “win” event will only be recorded for the fraction of respective bid responses that win an auction, thus there will generally be far less win events than bid response events—in any case the number of “win” events cannot possibly exceed the number of bid response events.

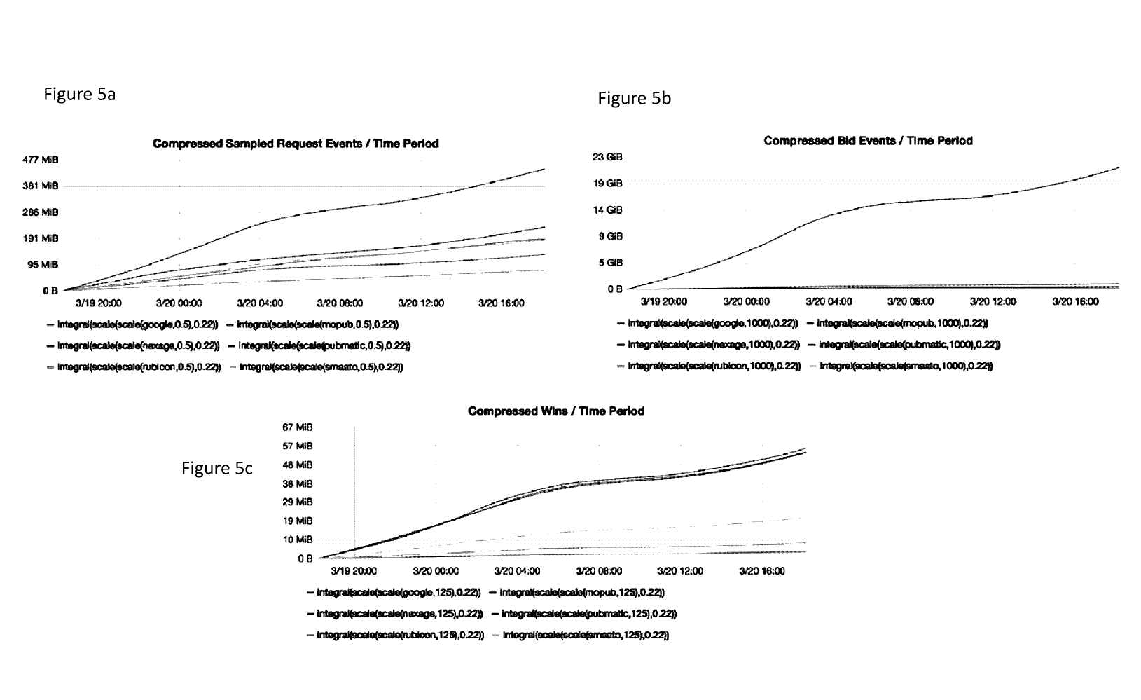

The three graphs 5a, 5b and 5c in FIG. 5 also all show the behaviour of auction activities at the DSP 108 with the same six ad exchanges, again throughout the past day (24 hours). However in contrast to the graphs of FIG. 4, FIG. 5a depicts the estimate of storage capacity for compressed auction request events only; FIG. 5b depicts the estimate of storage capacity for compressed bid response events only; and FIG. 5c depicts the estimate of storage capacity for compressed win events only. Further, the graphs of FIGS. 5a, 5b and 5c respectively show an estimate of storage capacity for an event type (requests, bid responses, wins) but cumulatively for each ad exchange over the entire time interval. Thus the graph curves in FIG. 5 all shown a cumulative increase over the 24 hour time interval. The choice to show the cumulative storage requirement of the data warehouse 114 may be effected in response to a user input at the dashboard service 118. As a result of the cumulative display setting for the graphs of FIGS. 5a, 5b and 5c, even though the event data is compressed, the estimated storage capacity requirement still rapidly builds up on a minute by minute basis. This is reflected by the increase in the order of magnitude of the data in the y-axes as compared to the graphs of FIG. 4.

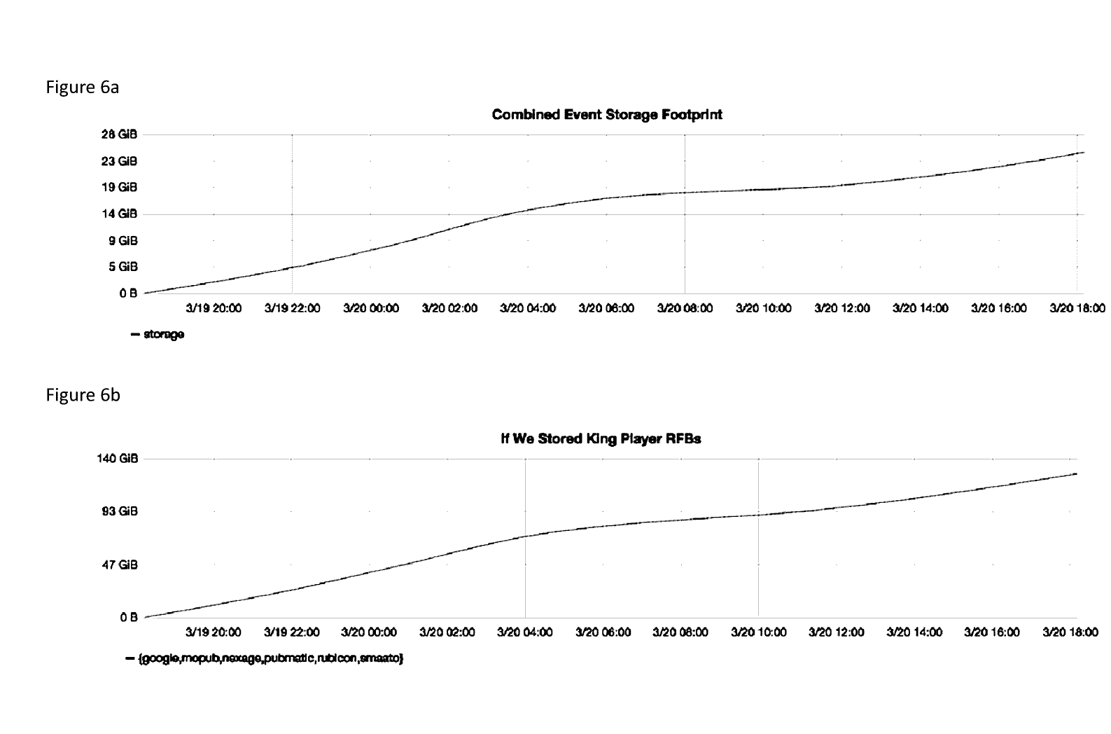

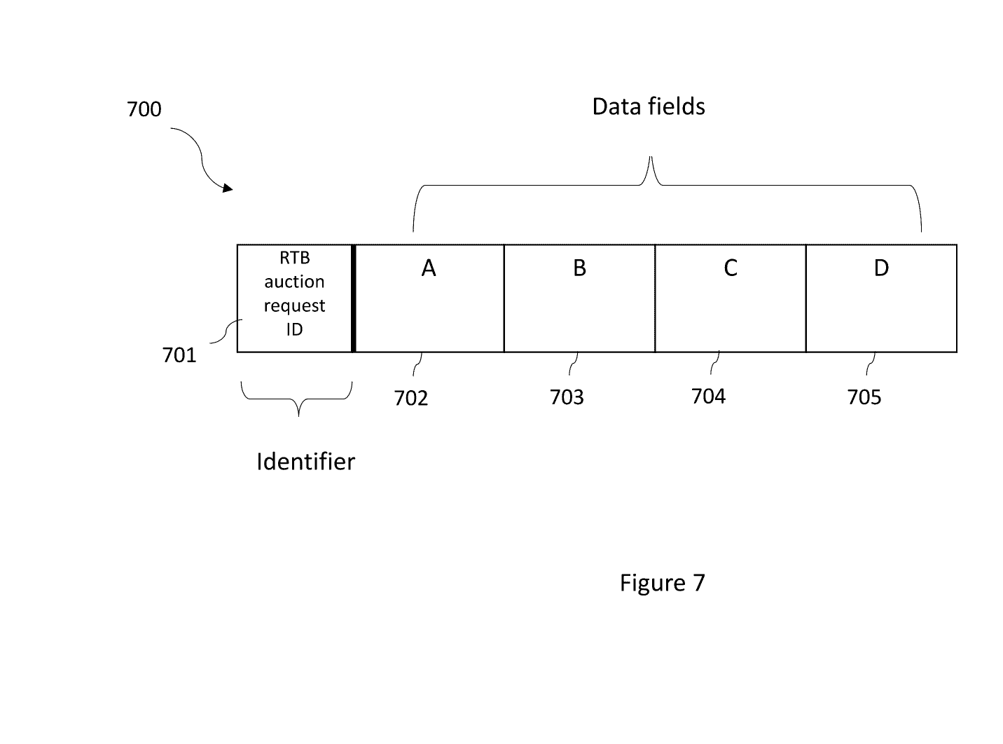

FIG. 6a shows a graph for the estimate of storage capacity required for compressed events of all types i.e. all of the requests, bid responses and wins, for all ad exchanges, cumulatively and over the 24 hour time interval.

FIG. 6b shows a graph for the estimate of storage capacity required for uncompressed events of all types, for all ad exchanges, cumulatively over the 24 hour time interval, but only for auction events associated with users that make up a particular subgroup of users that access a particular service (e.g. the subgroup 555 associated with the gaming service). As described above, this is achieved by the dashboard service 118 first determining a number of events associated with the users that make up subgroup 555 by retrieving the metric events for a defined time interval from the metrics server 116 and determining a ratio of total number of metric auction activities seen to the total number of “match” metrics seen. This result of the ratio is then multiplied by the estimated largest size of an event to provide the estimated storage capacity requirement of the data warehouse 114 over the time interval, but specifically for only storing auction event data that is associated with the users that make up subgroup 555.

The person skilled in the art will realise that the different approaches to implementing the methods, devices and system disclosed are not exhaustive, and what is described herein are certain embodiments. It is possible to implement the above in a number of variations without departing from the spirit or scope of the invention.

1. A method for predicting a storage capacity requirement for storing auction event data, the method comprising:
recording electronic auction activities communicated between a server and one or more ad exchanges, wherein each activity recorded comprises client data and is stored as a respective auction event;
recording metrics data for the auction activities;
estimating a size of an auction event; and
determining an estimate of a storage capacity requirement for storing said auction events in dependence on said metrics data and said estimated size of an auction event.

2. The method of claim 1, wherein the auction activities comprise: auction requests, bid responses and auction wins.

3. The method of claim 2, comprising recording a subset of auction requests.

4. The method of claim 3, further comprising recording all of the bid responses and auction wins.

5. The method of claim 3, wherein said recording a subset of auction requests is based on an adjustable sampling rate; and
wherein the adjustable sampling rate is based on a volume of auction requests.

6. The method of claim 5, comprising retrieving the metrics data; and
scaling down the number of retrieved metrics that indicate the auction requests in dependence on information on the sampling rate used in recording the subset of auction requests.

7. The method claim 1, comprising providing said auction events in the form of a log file for storing at a data warehouse; and
wherein the size of one auction event comprises the amount of data needed to represent the auction activity in a line of said log file.

8. The method of claim 1, comprising retrieving the metrics data based on a query structure that sets a time interval, so that metrics data from auction activities recorded during the time interval are retrieved.

9. The method of claim 2, further comprising recording metrics data for auction activities associated with users of a group that access a particular online service;
wherein the determining an estimate of a storage capacity requirement for storing said auction events is for storing auction events associated with the users of the particular online service.

10. The method of claim 9, further comprising determining, based on the metrics data, a ratio of total number of auction activities recorded to the number of auction requests that originate from said users of the particular online service; and
wherein said determining an estimate of a storage capacity requirement for storing auction events associated with the users of the particular online service comprises performing an operation using information of the result of the ratio and the estimated size of an auction event.

11. The method of claim 1, further comprising prior to recording the metrics data, filtering the metrics data such that metrics data according to predefined settings are recorded.

12. The method of claim 1, comprising applying an adjustable level of compression to the recorded auction events, the level of compression based on a volume of auction activities.

13. The method of claim 12, further comprising estimating the level of compression and scaling down the estimate of a storage capacity requirement based on the estimated level of compression.

14. The method of claim 1, comprising visually rendering the estimate of a storage capacity requirement for storing said auction events.

15. A system for predicting a storage capacity requirement for storing auction event data, the system comprising:
a server configured to record electronic auction activities communicated between said server and one or more ad exchanges, wherein each activity recorded comprises client data and is stored as a respective auction event;
a metrics server configured to record metrics data for the auction activities;
a dashboard service configured to estimate a size of an auction event; and
wherein the dashboard service is further configured to estimate a storage capacity requirement for storing said auction events in dependence on said metrics data and said estimated size of an auction event.

16. A method for predicting a storage capacity requirement for storing recorded auction activity data, the method comprising:
retrieving recorded metrics data based on electronic auction activities communicated between a server and one or more ad exchanges;
estimating a size of an auction activity as recorded by the server;
determining an estimate of a storage capacity requirement for storing recorded auction activities in dependence on said metrics data and said estimated size of a recorded auction activity; and
providing an indication of said estimated storage capacity requirement.

17. The method of claim 16, wherein the auction activities comprise: auction requests, bid responses and auction wins.

18. The method of claim 17, wherein said retrieving recorded metrics data comprises retrieving metrics data for auction activities associated with users of a group that access a particular online service;
wherein the determining an estimate of a storage capacity requirement for storing said recorded auction activities is for storing recorded auction activities associated with the users of the particular online service.

19. The method of claim 18, further comprising determining, based on the metrics data, a ratio of the total number of auction activities recorded to the number of auction requests that originate from said users of the particular online service; and
wherein said determining an estimate of a storage capacity requirement for storing recorded auction activities associated with the users of the particular online service comprises performing an operation using information of the result of the ratio and the estimated size of a recorded auction activity.

20. The method of claim 16, wherein the retrieved metrics data comprises filtered metrics such that metrics data according to predefined settings are retrieved.

21. A computing device adapted to predict a storage capacity requirement for storing recorded auction activity data, the computing device comprising processing means configured to:
retrieve recorded metrics data based on electronic auction activities communicated between a server and one or more ad exchanges;
estimate a size of an auction activity as recorded by the server;
determine an estimate of a storage capacity requirement for storing recorded auction activities in dependence on said metrics data and said estimated size of an auction activity; and
provide an indication of said estimated storage capacity requirement.

22. A non-transitory computer readable medium encoded with instructions for controlling a computing device to predict a storage capacity requirement for storing recorded auction activity data, wherein the instructions running on one or more processors result in:
retrieving recorded metrics data based on electronic auction activities communicated between a server and one or more ad exchanges;
estimating a size of an auction activity as recorded by the server;
determining an estimate of a storage capacity requirement for storing recorded auction activities in dependence on said metrics data and said estimated size of an auction activity; and
providing an indication of said estimated storage capacity requirement.

23. A method of determining a sampling rate for recording a subset of electronic auction activities, the method comprising;
receiving an indication of an available data capacity of a data warehouse;
retrieving recorded metrics data based on electronic auction activities communicated between a server and one or more ad exchanges;
estimating a size of an auction activity as recorded by the server;
applying one or more respective test sampling rates to the retrieved metrics data in order to obtain a respective one or more subsets of the metrics data;
based on the estimated size of an auction activity, estimating a data size of each of the one or more subsets of the metrics data, such that each estimated data size of the one or more subsets of the metrics data is associated with a respective one of the test sampling rates;
selecting the estimated data size of the one or more subsets of the metrics data suitable for the indicated available data capacity of the data warehouse; and
in response to said selecting, determining that said sampling rate for recording a subset of electronic auction activities be set in dependence on the test sampling rate that is associated with the selected estimated data size.

24. The method of claim 23 further comprising, transmitting to the server, an indication of the determined sampling rate, whereby the indication of the determined sampling rate causes the server to perform said recording a subset of electronic auction activities, the recorded subset of electronic auction activities being for storage at the data warehouse.

25. The method of claim 23 further comprising transmitting a request to the data warehouse for storing a volume of data at the data warehouse, information defining the volume of data being provided in said request; and
receiving a response from the data warehouse comprising the indication of an available data capacity of the data warehouse.
